(19) United States
(12) Patent Application Publication
(10) Pub. No.: US 2026/0048494 A1
(43) Pub. Date: Feb. 19, 2026

(54) TOOL HAMMER

(71) Applicant: LUCKY-BRAND INDUSTRIAL CO., LTD., TAICHUNG CITY (TW)

(72) Inventor: YING-CHIEH CHEN, TAICHUNG CITY (TW)

(21) Appl. No.: 18/808,503

(22) Filed: Aug. 19, 2024

(51) Int. Cl. B25G 3/26; B25G 1/10

(52) U.S. Cl. CPC B25G 3/26; B25G 1/102

(57) ABSTRACT

A tool hammer includes a hammer head, a handle, a positioning block, a fixing member, and a filler unit. The hammer head has a tapering hole on the top and a straight hole on the bottom. The handle has a combination part received in the straight hole. The positioning block is disposed in the tapering hole. Two corresponding sides of the positioning block are formed in a tapering shape and provided with a concave filling groove. The fixing member orderly passes through the positioning block and the combination part, so that the bottom face of the positioning block abuts against the top face of the combination part. The filler unit is filled in the tapering hole, the straight hole, and the filling groove. The combination strength between the hammer head and the handle is improved, effectively preventing detachment, enhancing durability and service life of the tool hammer.

### BACKGROUND OF THE INVENTI ON

### 1. Field of the Invention:

The present invention relates to tool hammers, and more particularly, to a tool hammer having an improved combination strength between the hammer head and the handle.

### 2. Description of the Related Art:

A tool hammer is used for carrying out various construction, maintenance, and building tasks. A conventional tool hammer comprises a hammer head and a handle.

Specifically, the structure between the hammer head and the handle tends to loosen over long and repeated usage duration. Such issue easily causes the conventional tool hammer to be difficult to control, which affects the performance of operation. During strikes, the loosened hammer head, especially the hammer head completely detaches from the handle, may cause deviations in hammering direction and force, which imposes risk of injury to the user or bystanders.

Currently tool hammers on the market fail to effectively address the loosening issue. Therefore, an improvement of the conventional tool hammer is desirable.

### SUMMARY OF THE INVENTION

The present invention aims at resolving the issue of the conventional tool hammer having the hammer head and the handle suffering from loosening or detachment after a long usage duration.

For achieving the aforementioned objectives, the present invention provides a tool hammer, comprising:

a hammer head having a tapering hole on a top face and a straight hole on a corresponding bottom face thereof, the tapering hole in communication with the straight hole, a radial cross-sectional area of the straight hole being equal to a smallest radial cross-sectional area of the tapering hole;

a handle having a combination part on one end, the combination part received in the straight hole;

a positioning block disposed in the tapering hole, two corresponding sides of the positioning block being formed in a tapering shape and each provided with a concave filling groove; a largest radial cross-sectional area of the positioning block being at least larger than a radial cross-sectional area of the tapering hole at a middle section of the tapering hole, a smallest radial cross-sectional area of the positioning block being smaller than the radial cross-sectional area of the straight hole;

a fixing member simultaneously fixed to the positioning block and the combination part, a bottom face of the positioning block abutting against a top face of the combination part; and

a filler unit filled in the tapering hole, the straight hole, and the filling groove.

With such configuration, the present invention improves the connection strength between the hammer head and the handle and prevents the detachment thereof, thereby increasing the durability and the service life of the overall tool hammer.

### BRIEF DESCRIPTION OF THE DRAWINGS

FIG. 1 is a perspective view of the tool hammer in accordance with an embodiment of the present invention.

FIG. 2 is a cross-sectional view taken along line A-A in FIG. 1.

FIG. 3 is a cross-sectional view taken along line B-B in FIG. 1.

FIG. 4 is an exploded view and partially enlarged view of FIG. 1.

FIG. 5 is a side view and partially enlarged view of the tool hammer in accordance with an embodiment of the present invention.

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion for explanation but not subject to the actual component proportion.

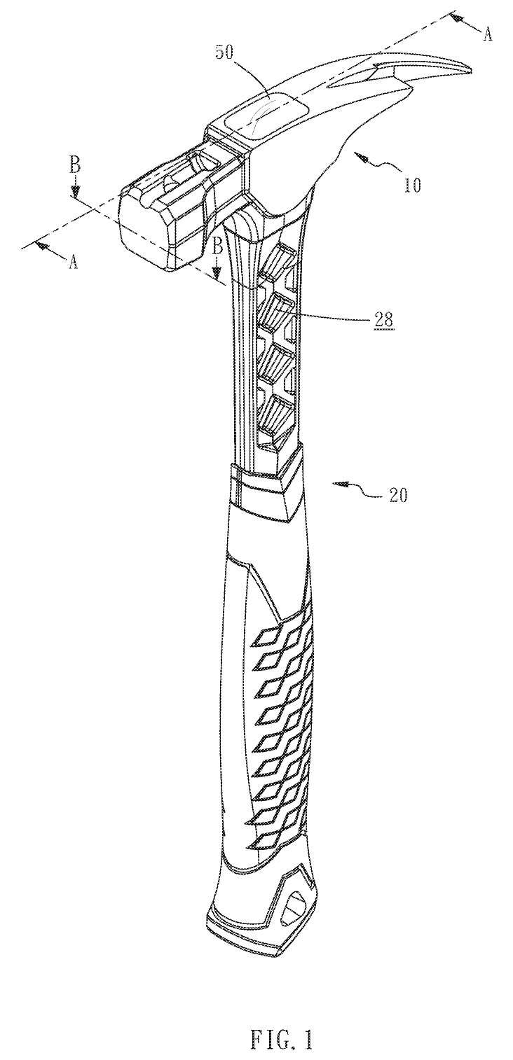

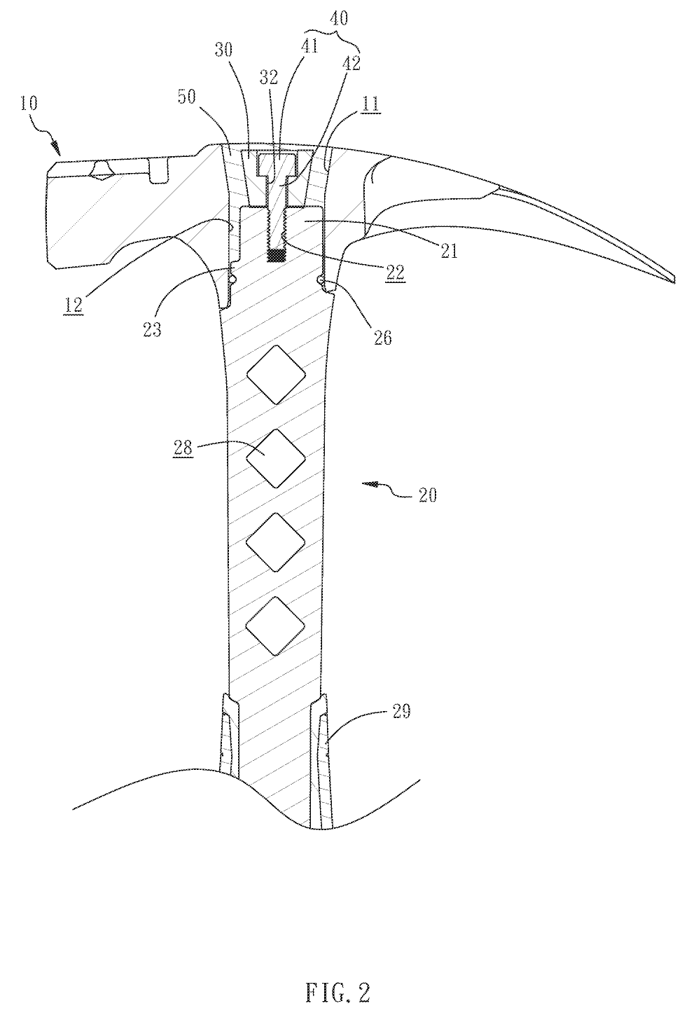

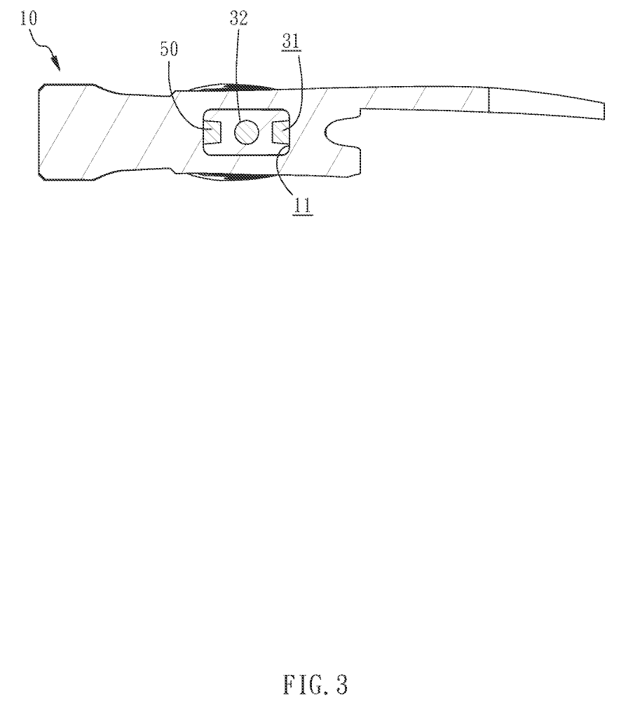

Referring to FIG. 1 to FIG. 5, the present invention provides a tool hammer, comprising a hammer head 10, a handle 20, a positioning block 30, a fixing member 40, and a filler unit 50. The hammer head 10 has a tapering hole 11 on the top face and a straight hole 12 on the corresponding bottom face, wherein the straight hole 12 is in communication with the tapering hole 11. The radial cross-sectional area of the straight hole 12 is the smallest radial cross-sectional area of the tapering hole 11. The handle 20 comprises a combination part 21 on one end. The combination part 21 comprises a first fixing bore 22. The combination part 21 is received in the straight hole 12. The handle 20 is formed of aluminum alloy or titanium alloy. The positioning block 30 is disposed in the tapering hole 11. Two corresponding sides of the positioning block 30 are formed in a tapering shape and each provided with a concave filling groove 31. The largest radial cross-sectional area of the positioning block 30 is at least larger than the radial cross-sectional area of the tapering hole 11 at a middle section of the tapering hole 11. The smallest radial cross-sectional area of the positioning block 30 is smaller than the radial cross-sectional area of the straight hole 12. The positioning block 30 comprises a second fixing bore 32 axially passing therethrough. The positioning block 30 is formed of heat-treated carbon steel. The fixing member 40 orderly passes through the second fixing bore 32 and the first fixing bore 22, so that the bottom face of the positioning block 30 abuts against the top face of the combination part 21. The filler unit 50 is filled in the tapering hole 11, the straight hole 12, and the filling groove 31. The filler unit 50 is formed of epoxy resin AB glue or thermoplastic polyurethane (TPU).

With such configuration, the diameter of the tapering hole 11 is applied as a confinement mechanism. When the positioning block 30 is placed into the tapering hole 11, the positioning block 30 is prevented from falling out from the straight hole 12. Therefore, by combining the positioning block 30 and the combination part 21 through the fixing member 40, the combination strength of the handle 20 in the hammer head 10 is improved. Also, once the filler unit 50 completely fills the tapering hole 11, the straight hole 12, and the filling groove 31, the handle 20 is more stably combined with the hammer head 10.

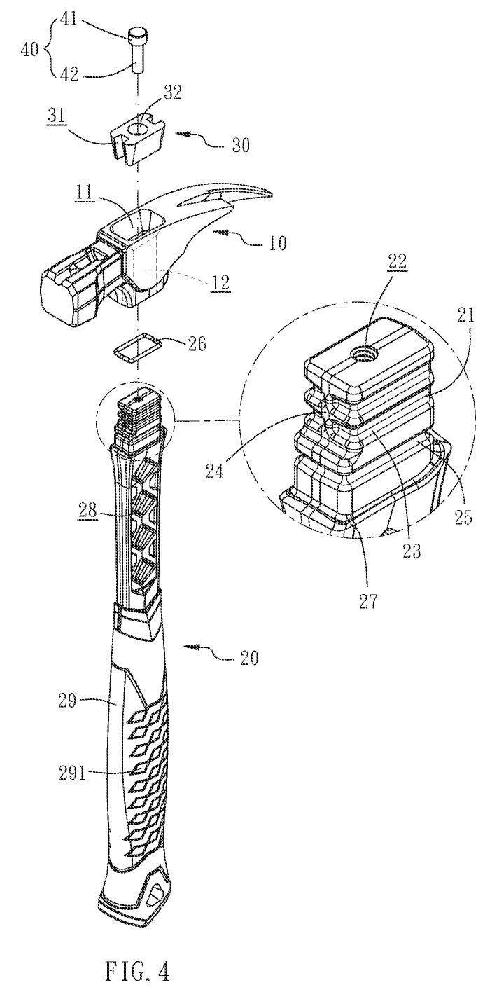

Referring to FIG. 4, the combination part 21 comprises a plurality of ring grooves 23 on the surface thereof, and the filler unit 50 is filled in the ring grooves 23. The ring grooves 23 are disposed in an upper and lower arrangement, with a reinforcement rib 24 axially disposed on the surface of the combination part 21 for dividing the ring grooves 23 into two sides. With such configuration, the ring grooves 23 increase the overall surface area of the combination part 21. Therefore, when the filler unit 50 is filled in the ring grooves 23, the filler unit 50 effectively improves the fixing strength and further strengthens the overall structure of the tool hammer. Furthermore, the placement of the reinforcement rib 24 not only effectively divides the ring grooves 23, reducing pressure impact on a single area and enhancing the overall structural strength, but also provides additional support, so as to reinforces the overall structural strength of the combination part 21, thereby lowering potential deformation occurring after long usage period.

Referring to FIG. 4, the combination part 21 comprises a position limiting groove 25 on one side of the ring grooves 23 away from the hammer head 10, with an oil seal 26 mounted around the position limiting groove 25. When the hammer head 10 is combined with the handle 20, the position limiting groove 25 is positioned in the straight hole 12. The oil seal 26 increases the friction between the combination part 21 and the wall surface of the straight hole 12, so as to ensure a more secure connection between the hammer head 10 and the handle 20. Also, the oil seal 26 prevents leakage of the filler unit 50 from the bottom of the straight hole 12.

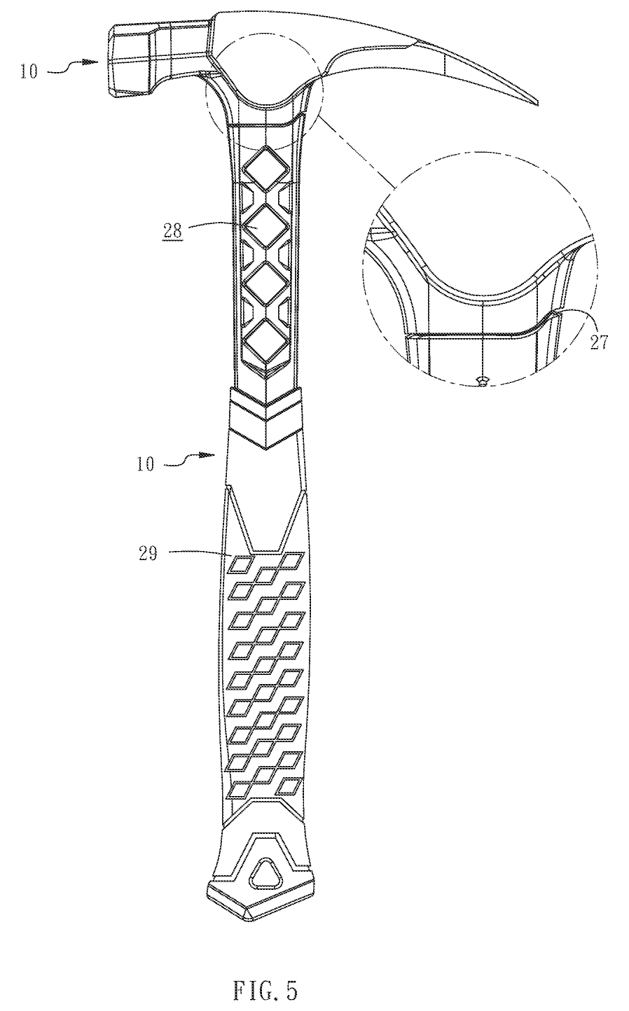

Referring to FIG. 4 and FIG. 5, the handle 20 comprises a supporting face 27 disposed at the junction between the handle 20 and the combination part 21. The side wall of the supporting face 27 and the combination part 21 is chamfered, instead of being formed in a right angle shape. The reason of this design is that, when the side wall of the supporting face 27 and the combination part 21 is formed in a right angle shape, the structure would be prone to fracturing under pressure. A chamfered configuration effectively disperses pressure, reduces the stress concentration at a specific point, and improves the stability and durability of the structure.

Referring to FIG. 4, the fixing member 40 comprises a head part 41 and a fastening part 42 extending downward therefrom. The radial cross-sectional area of the fastening part 42 is smaller than the radial cross-sectional area of the head part 41. The cross-sectional shape of the second fixing bore 32 is formed in a T shape corresponding to the shape of the fixing member 40. With such configuration, the T-shaped second fixing bore 32 allows the fixing member 40 to be easily inserted into or pulled out from the second fixing bore 32, increasing the assembly and disassembly efficiency; also, the fixing member 40 is stably positioned in the second fixing bore 32 and prevented from shaking.

Referring to FIG. 5 in view of FIG. 4, the surface of the handle 20 is provided with an anti-slip sleeve 29, which comprises a plurality of anti-slip patterns 291 concavely formed on the surface thereof. Also, in addition to this structure, although not explicitly shown in the drawings, the anti-slip patterns 291 are allowed to be directly embossed on the surface of the handle 20, without the need of a separate anti-slip sleeve 29. With either method, the anti-slip patterns 291 increase the friction resistance when the user grips the tool hammer, ensuring more stable usage of the tool hammer by the user, providing additional comfort and protection, and reducing the possibility of losing control due to slipping during usage.

Referring to FIG. 5, the handle 20 comprises a plurality of weight reducing bores 28 radially passing therethrough. The weight reducing bores 28 reduce the overall weight of the handle 20.

With the foregoing configuration, the present invention achieves following advantages.

The present invention resolves the detachment issue. With the positioning block 30 and the fixing member 40, the combination strength between the hammer head 10 and the handle 20 is improved, and the detachment is prevented, thereby increasing the durability and service life of the tool hammer.

The present invention improves the usage safety. With the fixing member 40 passing through the second fixing bore 32 and the first fixing bore 22, and the filler unit 50 being filled in the tapering hole 11, the straight hole 12, and the filling groove 31, the possibility of detachment between the hammer head 10 and the handle 20 is reduced, so that the hammer head 10 and the handle 20 are more stably combined, reducing the safety risks associated with the detachment of the hammer head 10, thereby enhancing the safety of both users and bystanders, and also lowering maintenance cost for the tool.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A tool hammer, comprising:
a hammer head having a tapering hole on a top face and a straight hole on a corresponding bottom face thereof, the tapering hole in communication with the straight hole, a radial cross-sectional area of the straight hole being equal to a smallest radial cross-sectional area of the tapering hole;
a handle having a combination part on one end, the combination part received in the straight hole;
a positioning block disposed in the tapering hole, two corresponding sides of the positioning block being formed in a tapering shape and each provided with a concave filling groove; a largest radial cross-sectional area of the positioning block being at least larger than a radial cross-sectional area of the tapering hole at a middle section of the tapering hole, a smallest radial cross-sectional area of the positioning block being smaller than the radial cross-sectional area of the straight hole;
a fixing member simultaneously fixed to the positioning block and the combination part, a bottom face of the positioning block abutting against a top face of the combination part; and
a filler unit filled in the tapering hole, the straight hole, and the filling groove.

2. The tool hammer of claim 1, wherein a surface of the combination part comprises a plurality of ring grooves, and the filler unit is filled in the ring grooves.

3. The tool hammer of claim 2, wherein the ring grooves are disposed in an upper and lower arrangement, with a reinforcement rib axially disposed on the surface of the combination part for dividing the ring grooves into two sides.

4. The tool hammer of claim 3, wherein the combination part comprises a position limiting groove, with an oil seal mounted around the position limiting groove; when the hammer head is combined with the handle, the position limiting groove is placed in the straight hole.

5. The tool hammer of claim 4, wherein the handle comprises a supporting face disposed at a junction between the handle and the combination part; a side wall of the supporting face and the combination part are chamfered.

6. The tool hammer of claim 5, wherein the combination part comprises a first fixing bore; the positioning block comprises a second fixing bore axially passing therethrough; the fixing member orderly passes through the second fixing bore and the first fixing bore; the fixing member comprises a head part and a fastening part extending downward therefrom; a radial cross-sectional area of the fastening part is smaller than a radial cross-sectional area of the head part; a cross-sectional shape of the second fixing bore is formed in a T shape corresponding to a shape of the fixing member.

7. The tool hammer of claim 6, wherein the handle comprises a plurality of weight reducing bores radially passing therethrough.

8. The tool hammer of claim 7, wherein a plurality of anti-slip patterns are embossed on a surface of the handle.

9. The tool hammer of claim 7, wherein the handle comprises an anti-slip sleeve disposed on a surface of the handle; a plurality of anti-slip patterns are embossed on a surface of the anti-slip sleeve.

10. The tool hammer of claim 1, wherein the handle is formed of aluminum alloy or titanium alloy.

11. The tool hammer of claim 1, wherein the positioning block is formed of heat-treated carbon steel.

12. The tool hammer of claim 1, wherein the filler unit is formed of epoxy resin AB glue or thermoplastic polyurethane (TPU).
